(19) United States
(12) Patent Application Publication
(10) Pub. No.: US 2026/0086616 A1
(43) Pub. Date: Mar. 26, 2026

(54) ELECTRONIC DEVICE AND POWER CONSUMPTION NOTIFICATION METHOD THEREOF

(71) Applicant: ASUSTeK COMPUTER INC., Taipei City (TW)

(72) Inventors: Chi-Lung Chen, Taipei City (TW); Shu-Hong Yeh, Taipei City (TW)

(73) Assignee: ASUSTeK COMPUTER INC., Taipei City (TW)

(21) Appl. No.: 19/212,723

(22) Filed: May 20, 2025

(30) Foreign Application Priority Data
Sep. 24, 2024 (TW) 113136109

(51) Int. Cl. G06F 1/26

(52) U.S. Cl. CPC G06F 1/26

(57) ABSTRACT

An electronic device and a power consumption notification method thereof are provided. The method includes the following steps. A plurality of applications currently running in a background are identified. A power consuming application having a power consumption behavior is found from the applications. A power consumption notification operation is performed in a circumstance where the power consuming application does not have an agent program.

### CROSS-REFERENCE TO RELATED APPLICATION

This application claims the priority benefit of Taiwan application serial no. 113136109, filed on Sep. 24, 2024. The entirety of the above-mentioned patent application is hereby incorporated by reference herein and made a part of this specification.

### BACKGROUND

### Technical Field

The disclosure relates to an electronic device optimizing user experience and a power consumption notification method adopted for the electronic device.

### Description of Related Art

Today's electronic devices (e.g., personal computers, laptops, smartphones, and tablets) mostly have power consumption notification mechanisms. The purpose is to alert users when an application (APP) running in the background exhibits unexpected power consumption behavior, which could cause unnecessary power consumption. Therefore, during the notification, applications running in the foreground or those noticeable to the user are skipped. However, existing mechanisms do not take into account whether the application exhibiting unexpected power consumption behavior has an agent program. This may result in the execution of a power consumption notification for an application even when the agent program has already been noticed by the user, causing the user to feel unnecessarily disturbed, leading to a poor user experience and operational perception.

### SUMMARY

The disclosure provides a power consumption notification method applicable to an electronic device. The method includes the following steps. Multiple applications currently running in the background are identified. A power consuming application having a power consumption behavior is found among the multiple applications. A power consumption notification operation is performed when the power consuming application does not have an agent program.

The disclosure also provides an electronic device, including a storage device, a notification device, and a processor. The storage device is configured to store multiple system program modules. The notification device is configured to perform a power consumption notification operation. The processor, coupled to both the storage device and the notification device, is configured to load and execute the system program modules to identify multiple applications currently running in a background, find a power consuming application, and perform the power consumption notification operation through the notification device when the power consuming application does not have an agent program.

Based on the above, the electronic device and the power consumption notification method thereof of the disclosure are able to take into account the presence of an agent program in the applications. This prevents unnecessary disturbances to the user by avoiding redundant notifications when the agent program is already noticeable to the user, thereby providing a better user experience and smoother operation.

To make the features and advantages of the disclosure more comprehensible, several embodiments accompanied with drawings are described in detail as follows.

### BRIEF DESCRIPTION OF THE DRAWINGS

FIG. 1 is a block diagram illustrating an electronic device according to an embodiment of the disclosure.

FIG. 2 is a flowchart of the steps of a power consumption notification method according to an embodiment of the disclosure.

FIG. 3 is a flowchart of the steps of a power consumption notification method according to an embodiment of the disclosure.

### DESCRIPTION OF THE EMBODIMENTS

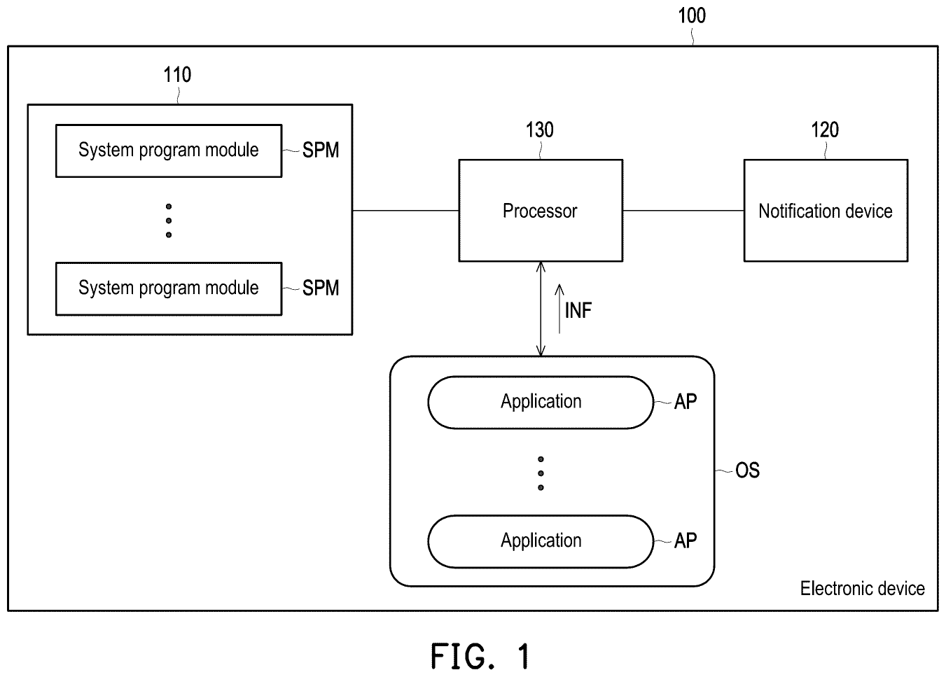

Please refer to FIG. 1. An electronic device 100 in this embodiment is, for example, an electronic product such as a personal computer, smartphone, personal digital assistant (PDA), personal digital assistant phone, laptop, tablet, or smart TV. The electronic device 100 includes a storage device 110, a notification device 120, and a processor 130.

The storage device 110 is, for example, any type of fixed or removable random access memory (RAM), read-only memory (ROM), flash memory, hard disk, or other similar devices, hard disks, or similar elements, or a combination of the aforementioned elements. The storage device 110 may be used to store multiple system program modules SPM. These system program modules SPM are, for example, used to execute power-saving related functions, including power consumption detection, and to manage the corresponding relationship between applications and agent programs.

The notification device 120 is, for example, a display using a liquid crystal display (LCD), light-emitting diode (LED), field emission display (FED), or other types of panels. The notification device 120 may be used to perform power consumption notification operations. For example, the notification device 120 may display a notification screen (containing messages or windows) to convey messages or any information to the user. In another embodiment, however, the notification device 120 may also be, for example, a speaker that plays sounds to convey messages to the user. The disclosure is not limited to this.

The processor 130 is, for example, a central processing unit (CPU), or another programmable general-purpose or special-purpose microprocessor, digital signal processor (DSP), programmable controller, application specific integrated circuit (ASIC), or other similar elements or a combination of the aforementioned elements. The processor 130 is coupled to the storage device 110 and the notification device 120. The processor 130 may load and execute multiple system program modules SPM from the storage device 110 to control power consumption notification operations. Additionally, the processor 130 may obtain various information INF related to applications running in the background or foreground from an operating system OS installed on the electronic device 100 (e.g., Microsoft Windows or Android system).

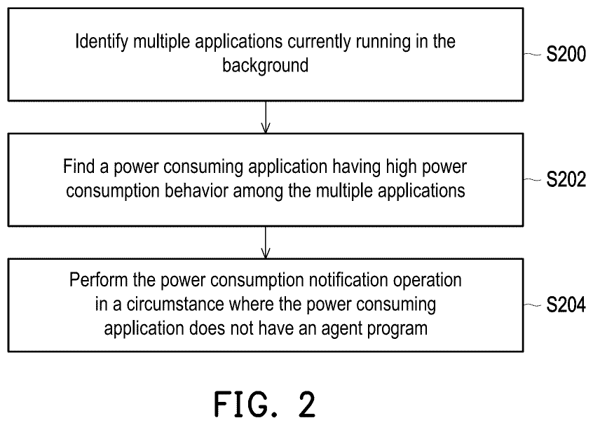

Please refer to both FIG. 1 and FIG. 2. The power consumption notification method in this embodiment can be applied to the electronic device 100 in FIG. 1. The steps of the power consumption notification method of the disclosure are described below in conjunction with the components of the electronic device 100.

First, in step S200, the processor 130 identifies multiple applications AP currently running in the background based on the obtained information INF. For example, if the screen of the electronic device 100 is turned off while the application AP is running for activities such as listening to music, listening to the radio, or navigation, the application AP may switch to running in the background.

Next, in step S202, the processor 130 finds a power consuming application having power consumption behavior (with great power consumption) from among the multiple applications AP. For example, the operating system OS contains various performance testing tools. These performance testing tools can be used to record log data of the activity history of the multiple applications AP running in the background (including activity content such as waking up the system, accessing the network, collecting, analyzing, processing, or downloading data, etc., as well as activity duration), and based on the recorded data, calculate the power consumption of each application AP running in the background and provide this information to the processor 130. As a result, the processor 130 can determine whether the power consumption of any of the applications AP running in the background exceeds a predetermined power threshold value and designate the application AP with power consumption greater than the power threshold value as the power consuming application.

Finally, in step S204, in a circumstance where the power consuming application does not have an agent program, the processor 130 performs the power consumption notification operation through the notification device 120. In this embodiment, the agent program refers to another program that is called to perform activities by the corresponding application (APP). For example, an application (APP) may provide an interface but call another program to play music. In this case, the program playing music is the agent program of the application (APP). The called agent program may be recorded in the storage device 110.

The processor 130 can determine, based on the obtained information INF, whether the power consuming application found among the multiple applications AP has the agent program. When the power consuming application does not have the agent program, the processor 130 can perform the corresponding power consumption notification operation through the notification device 120 (e.g., displaying a notification screen that includes messages or windows to convey the name or power consumption of the power consuming application to the user).

When the power consuming application has the agent program, the processor 130 does not perform the corresponding power consumption notification operation through the notification device 120. This avoids generating the unnecessary feeling of disturbance when the agent program has already been noticed by the user.

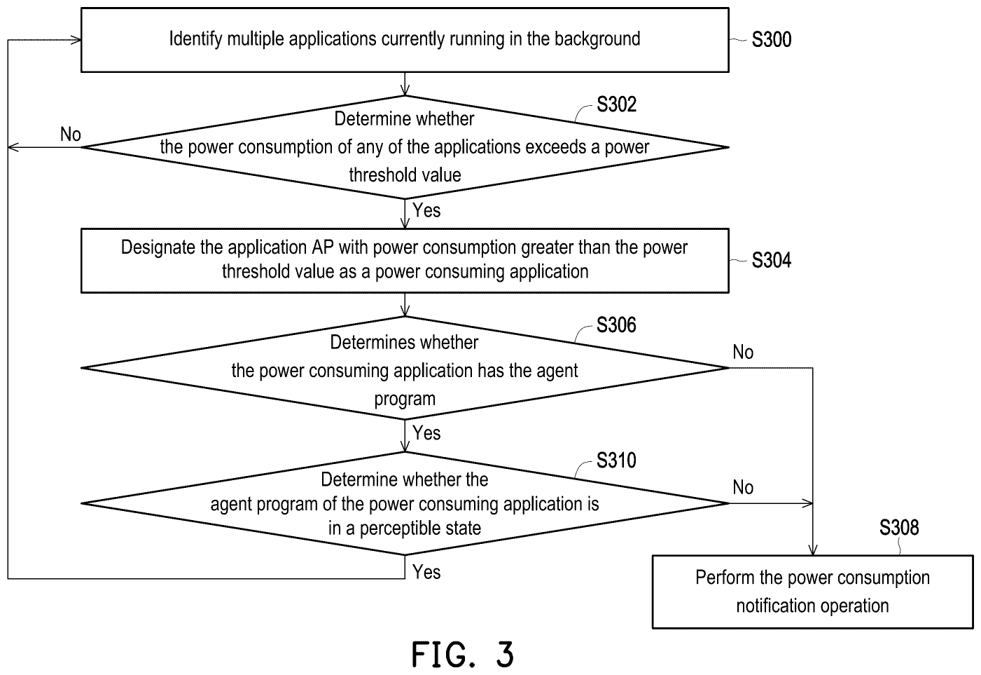

The following is another example illustrating the detailed steps of the power consumption notification method of the disclosure. Please refer to both FIG. 1 and FIG. 3. The power consumption notification method in this embodiment can be applied to the electronic device 100 in FIG. 1. The steps are as follows.

First, in step S300, the processor 130 identifies multiple applications AP currently running in the background based on the information INF obtained from the operating system OS.

Next, in step S302, the processor 130 determines whether the power consumption of any of the multiple applications AP exceeds a power threshold value. If not, the process returns to step S300 to continue checking the multiple applications AP currently running in the background. If yes, in step S304, the processor 130 designates the application AP with power consumption greater than the power threshold value as the power consuming application.

Then, in step S306, the processor 130 determines, based on the obtained information INF, whether the power consuming application found among the multiple applications AP has the agent program. If the power consuming application does not have the agent program, in step S308, the processor 130 adds the power consuming application to a power consumption notification list, so that the corresponding power consumption notification operation can be performed through the notification device 120 (e.g., displaying a notification screen that includes messages or windows to convey the name or power consumption of the power consuming application to the user).

When the power consuming application has the agent program, in step S310, the processor 130 determines whether the agent program of the power consuming application is in a perceptible state. In this embodiment, the perceptible state refers to a situation where the agent program is being executed in the foreground and uses a display to show images or a speaker to play sounds, or any state that can easily be noticed by the user.

If the agent program is not in the perceptible state, the processor 130 adds the power consuming application corresponding to the non-perceptible agent program to the power consumption notification list, so that the corresponding power consumption notification operation can be performed through the notification device 120.

If the agent program is in the perceptible state, the processor 130 does not perform the corresponding power consumption notification operation through the notification device 120 and returns to step S300 to continue processing.

It should be noted that there may be more than one power consuming application found among the multiple applications AP. The embodiment of the disclosure does not impose a limitation on this. As long as the power consuming application found does not have the agent program, or the corresponding agent program is not in the perceptible state, it can be added to the power consumption notification list. In this way, the corresponding power consumption notification operation can be performed for each power consuming application on the notification list through the notification device 120.

Additionally, in an embodiment, as long as the power consumption notification service is enabled in the operating system OS, the processor 130 will continuously repeat the steps of the power consumption notification method as shown in FIG. 3 until the service is turned off.

In summary, the electronic device and the power consumption notification method thereof of the disclosure take into account whether the agent program of an application is noticeable to the user. This prevents the user from feeling unnecessarily disturbed by redundant power consumption notifications, thereby providing a better user experience and smoother operation.

What is claimed is:

1. A power consumption notification method, applicable to an electronic device, comprising:
identifying a plurality of applications currently running in a background;
finding at least one power consuming application having a power consumption behavior from the plurality of applications; and
performing a power consumption notification operation in a circumstance where the at least one power consuming application does not have an agent program.

2. The power consumption notification method according to claim 1, wherein finding the at least one power consuming application having the power consumption behavior from the plurality of applications comprises:
determining whether a power consumption of any of the plurality of applications is greater than a power threshold value;
if so, designating at least one of the any of the plurality of applications with the power consumption greater than the power threshold value as the at least one power consuming application.

3. The power consumption notification method according to claim 1, wherein performing the power consumption notification operation in the circumstance where the at least one power consuming application does not have the agent program comprises:
determining whether the at least one power consuming application has the agent program; and
when the at least one power consuming application does not have the agent program, performing the corresponding power consumption notification operation.

4. The power consumption notification method according to claim 3, further comprising:
when the at least one power consuming application has the agent program, determining whether the agent program of the at least one power consuming application is in a perceptible state;
when the agent program is not in the perceptible state, adding the power consuming application corresponding to the agent program not in the perceptible state to a power consumption notification list, thereby performing the corresponding power consumption notification operation; and
when the agent program is in the perceptible state, not performing the corresponding power consumption notification operation.

5. The power consumption notification method according to claim 4, wherein the perceptible state indicates a state of displaying a screen using a display or playing a sound using a speaker during an execution period.

6. An electronic device, comprising:
a storage device, configured to store a plurality of system program modules;
a notification device, configured to perform a power consumption notification operation; and
a processor, coupled to the storage device and the notification device, and configured to load and execute the plurality of system program modules to:
identify a plurality of applications currently running in a background;
find at least one power consuming application having a power consumption behavior from the plurality of applications; and
perform the power consumption notification operation through the notification device in a circumstance where the at least one power consuming application does not have an agent program.

7. The electronic device according to claim 6, wherein the processor determines whether a power consumption of any of the plurality of applications is greater than a power threshold value,
if so, the processor designates at least one of the any of the plurality of applications with the power consumption greater than the power threshold value as the at least one power consuming application.

8. The electronic device according to claim 6, wherein the processor determines whether the at least one power consuming application has the agent program,
when the at least one power consuming application does not have the agent program, the processor performs the corresponding power consumption notification operation through the notification device.

9. The electronic device according to claim 8, wherein when the at least one power consuming application has the agent program, the processor determines whether the agent program of the at least one power consuming application is in a perceptible state,
when the agent program is not in the perceptible state, the processor adds the power consuming application corresponding to the agent program not in the perceptible state to a power consumption notification list, thereby performing the corresponding power consumption notification operation through the notification device,
when the agent program is in the perceptible state, the processor does not perform the corresponding power consumption notification operation through the notification device.

10. The electronic device according to claim 9, wherein the perceptible state indicates a state of displaying a screen using a display or playing a sound using a speaker during an execution period.
